(19) United States
(12) Patent Application Publication
(10) Pub. No.: US 2012/0053001 A1
(43) Pub. Date: Mar. 1, 2012

(54) ADJUSTING DRIVE HAVING AN EMERGENCY ACTUATOR

(75) Inventors: Christof Blech, Renningen (DE); Gunnar Wilke, Lotte (DE)

(73) Assignee: MAGNA CAR TOP SYSTEMS GMBH, Bietigheim-Bissingen (DE)

(21) Appl. No.: 13/215,319

(22) Filed: Aug. 23, 2011

(30) Foreign Application Priority Data
Aug. 25, 2010 (DE) 10 2010 035 286.1

(51) Int. Cl. F16H 57/08; F16H 37/04

(52) U.S. Cl. 475/149

(57) ABSTRACT

An adjustment assembly includes a worm gear drive, a planetary gear drive, an emergency actuator, and a housing. The worm gear drive is configured to be driven by a drive motor. The planetary gear drive has a ring gear with external teeth. The planetary gear drive is configured to be driven by the worm gear drive. The emergency actuator has a worm screw. The housing houses the worm gear drive, the planetary gear drive, and the emergency actuator. The housing has a cylindrical receptacle. The ring gear, by the external teeth, is accommodated and guided by the cylindrical receptacle in the housing. The external teeth of the ring gear are engaged with the worm screw of the emergency actuator whereby the emergency actuator is configured to act on the planetary gear drive.

### CROSS-REFERENCE TO RELATED APPLICATIONS

This application claims foreign priority benefits under 35 U.S.C. §119(a)-(d) to DE 10 2010 035 286.1, filed Aug. 25, 2010, which is hereby incorporated by reference in its entirety.

### TECHNICAL FIELD

The present invention relates to an adjusting drive for vehicles in which the adjusting drive has an emergency actuator.

### BACKGROUND

Electric motors having gear assemblies are used to actuate vehicular closable openings such as trunks, hoods, windows, sliding roofs, convertible folding roofs, etc. The gear assemblies provide gear multiplication or reduction depending on the component to be actuated. Thus, for example, the motor for the actuation of a vehicle door window is equipped with step-up gearing as relatively quick opening and closing of the window is desired.

Another example involves a locking hook of a convertible roof. The locking hook is used to pull the roof over its remaining closing path when the roof is near its closed position. Such a closure drive requires installation space for appropriately designed and sized motors. Such space is generally not present in a movable roof, particularly in a soft-top roof. A solution is to use a relatively small and less powerful motor which by step-down gearing actuates the locking hook and thus transmits the required pulling force via a fairly high rotational speed of the motor and the gear reduction thereof.

Of course, such adjusting/closure drives may be used for vehicular trunks and tailgates. Here too, the motor and the downstream step-up or step-down gear assembly are appropriately designed for the required load and motion sequences. Such a combination of motors and gear assemblies is increasingly replacing hydraulic adjusting drives. Cog wheel gearing, spur gearing, or planetary gearing may be used as step-up or step-down gearing. In addition, worm gear drives are used as they generally operate with low noise and can transmit large forces.

EP 1 033 272 B1 describes a three-stage assembly of a closure drive for a vehicular folding top. A worm screw engages a worm wheel of a worm gear drive and is driven axially by a drive shaft of a drive motor. A gear wheel is mounted on the shaft of the worm wheel and is connected to the worm wheel in a rotationally fixed manner. The gear wheel engages an additional gear wheel of the next gear stage with the gear ratio being a step-down gear assembly. The additional gear wheel serves as a planet carrier of a planetary gear drive. Planet wheels are rotatably supported on the planet carrier. The planet wheels pivot about the center axis of the planet carrier and mesh with a sun wheel when the planet carrier rotates. The entire gear assembly is mounted on a plate. A flat closing cover whose shape matches the gear wheels is placed over the gear assembly and screwed to the plate. The cover contains bearing points of the gear assembly. The axle of the planet carrier and thus of the sun wheel passes through the housing in the region of the plate. The end side of the axle is a flange having a continuous central groove. This flange acts as the connecting plane to the component to be actuated.

DE 10 2004 046 098 A1 (corresponding to U.S. Pat. No. 7,407,201) describes a closure drive for a vehicular folding top. The gear assembly is connected to a locking hook for the folding top. The motor acts on a bevel gear of the gear assembly. The bevel gear is connected to a worm screw via a shaft and the worm screw engages in a worm wheel. The double deflection of the drive torque of the motor is provided for driving an additional gear assembly. The additional gear assembly is a planetary gear drive. The sun wheel of the planetary gear drive is rigidly connected to the worm wheel of the worm gear drive and projects from the worm wheel. Planet wheels mesh with the sun wheel and a ring gear. The planet wheels are mounted on a planet carrier via bearing assemblies, thus ensuring their positions relative to one another. A worm screw acting at 90° engages the ring gear. This worm screw is a component of a shaft which over its vertical extension is located inside the closure housing and which has a polygon socket on its side. This worm screw is used for emergency actuation of the closure whereby a suitable tool such as a hexagonal socket wrench engages through an opening in the housing and in the polygon socket of the worm screw thus allowing the worm screw to be rotated. During normal operation, the ring gear is fixed in position by this worm screw such that the gearing parts rotate in response to a drive torque from the motor. In particular, the planet carrier together with the planet wheels rotate and this rotational motion is transferred to the locking hook via a connector. This emergency actuation worm screw engages in the external teeth of the ring gear with this worm screw and the planetary gear drive being mounted in an upright vertical position.

DE 10 2005 015 166 A1 describes an adjustment unit for a convertible vehicle. The adjustment unit includes a manual emergency actuator. The drive shaft of the motor is in the form of a worm screw having regions with different pitches. In at least one region, the worm screw has a pitch with a small setting angle. A worm wheel which meshes with the worm screw in this region is able to rotate when the worm screw rotates, but due to the small setting angle self-locking results in the un-actuated state. Another region of the worm screw has a pitch with a small setting angle. The thread direction of the worm screw counteracts that of the first worm screw. Here as well, a worm wheel which meshes with the worm screw is set in rotation when the worm screw rotates. Since both worm screws are self-locking due to the small setting angle and counteracting thread directions, the gearing or the elements connected thereto and to be moved are not able to actuate on their own. As an emergency actuator, in the further progression of the worm screw a partial region of the worm screw has a large pitch with which a corresponding worm wheel engages. As a result of the large pitch, the worm screw is able to rotate when the worm wheel rotates so that this region acts as an emergency actuator for the overall gear assembly. In order to inactivate the self-locking feature of the two worm gear drives having a small setting angle, the worm wheel of the emergency actuator is rigidly connected to an additional gear wheel. The additional gear wheel engages with the worm wheels of the gear assembly having a smaller setting angle. The rotational motion deactivates the self-locking feature.

### SUMMARY

An object of the present invention includes an adjusting/closure drive for adjusting movable vehicular components in which the adjusting/closure drive has a particularly flat design, contains an emergency actuator integrated therein, and can be manufactured economically using a relatively small number of parts.

In carrying out the above object and other objects, the present invention provides an adjustment assembly. The adjustment assembly includes a worm gear drive, a planetary gear drive, an emergency actuator, and a housing. The worm gear drive is configured to be driven by a drive motor. The planetary gear drive has a ring gear with external teeth. The planetary gear drive is configured to be driven by the worm gear drive. The emergency actuator has a worm screw. The housing houses the worm gear drive, the planetary gear drive, and the emergency actuator. The housing has a cylindrical receptacle. The ring gear, by the external teeth, is accommodated and guided by the cylindrical receptacle in the housing. The external teeth of the ring gear are engaged with the worm screw of the emergency actuator whereby the emergency actuator is configured to act on the planetary gear drive.

Embodiments of the present invention are directed to an adjustment drive for adjusting movable vehicular components between intermediate and end positions. The adjustment drive includes an electric motor and a gear assembly connected downstream from the motor.

The motion of a component to be adjusted may proceed rapidly or particularly high forces may be transmitted. For a rapid adjustment motion, a simple gear assembly coupled to the component to be adjusted may be used and the adjustment speed may be set corresponding to the selected gear ratio and the drive speed of the motor. For the transmission of large forces, a worm gear drive and multiple gear assemblies connected in succession may be used. The gear assemblies can be arranged in parallel or in series. A worm screw is located in the extension of the drive shaft of the motor. The worm screw engages in the external teeth of a worm wheel of the worm gear drive. This configuration in the use of the worm gear drive is advantageous due as the screwing motion of the worm screw relative to the worm wheel may be selected such that self-locking of this gear assembly is not possible in the un-actuated state. Thus, in a simple manner, it is ensured that unintended adjustment of the gear assembly does not occur on its own.

Abrupt loads of peak forces typically do not occur when a worm gear drive is used. Large forces and torques may be transmitted as a result of a high gear reduction which is selected corresponding to the pitch of the worm screw. Further, this type of gearing operates at a particularly low noise level.

The space-saving configuration of the worm gear drive is advantageous for reducing the installation space. As such, in accordance with embodiments of the present invention, a planetary gear drive is provided parallel to the worm wheel of a worm gear drive. This parallel design of the two gear assemblies requires little installation space since both gear assemblies together with their components may be provided with a relatively flat design. Both gear assemblies may thus be accommodated in a shared housing. The selection of corresponding dimensions of two gearing housing halves allows a simple design and installation of the housing. Thus, as a result of a parting plane of the two housing halves, the essential components, in particular the accommodation and fixing of the motor, may be provided inside the housing. By using separately provided bearing points or openings, the housing may be easily assembled and positioned in the vehicle.

In order to optimize the installation space and the weight of the housing for accommodating the motor and the gear assembly, the housing may be made of a material having high rigidity such as a metal and/or a composite. Of course, other elements of the drive or the gear assembly may also be made of plastic.

An adjustment drive in accordance with embodiments of the present invention generally includes: a drive motor having a drive worm; a worm gear drive having a worm wheel; a planetary gear drive having a ring gear, planet wheels, a planet carrier, and a sun wheel; and an emergency actuator having a worm screw. The worm gear drive is directly coupled to the drive motor by engagement between the worm wheel of the worm gear drive and the drive worm of the drive motor. The planetary gear drive is situated parallel to the worm wheel. The planetary gear drive is decoupled from the worm wheel and is situated parallel thereto so that the ring gear with the planet wheels are able to move independently of the worm wheel. The sun wheel is the only fixed connection between the two gear assemblies and is rigidly connected to the worm wheel. The planet carrier is situated on the side of the planetary gear drive opposite from the worm wheel. Via the planet carrier the planet wheels are positioned by axles rigidly connected to the planet carrier. The axles of the planet wheels may be designed as shafts. The planet carrier may be designed such that it covers the entire planetary gear drive in the manner of a locking disk.

The worm screw of the emergency actuator is provided in the housing on the side of the planetary gear drive opposite from the motor. The worm screw engages in external teeth of the ring gear of the planetary gear drive. The free end of the worm screw can be actuated from outside the housing by a bevel gear assembly having bevel gear wheels. For normal drive via the motor, the emergency actuator is free of load and the ring gear remains fixed in position due to the connection to the worm screw of the emergency actuator. During emergency operation, the ring gear is set in rotation via the worm screw of the emergency actuator. This rotational motion is transferred to the component to be adjusted on account of the internal teeth of the ring gear together with the meshing planet wheels and planet carrier of the ring gear. The drive worm of the drive motor and the worm wheel of the worm gear drive do not rotate so that only the planet wheels are set in motion about the stationary sun wheel. In the present case, there is a reversal of the mode of operation of the drive.

As a result of the design of a flat gear assembly housing whose maximum thickness corresponds to the outer diameter of the drive motor it is possible to install such adjusting/closure drives in small installation spaces. This space may in particular be the front receptacle area of a movable roof or tailgate of a vehicle. In this case, the adjusting/closure drive is used for locking or positioning the element to be adjusted in an end position. The components to be adjusted may be, for example, other closures such a trunk or sliding roof or seat adjusters or window actuators. In the present example it is practical for the adjusting drive to be in operative connection with a closing element in the form of a locking hook, whereby the locking hook may be situated or aligned orthogonally with respect to the gear assembly.

Emergency actuation is achieved via the bevel gear assembly. The bevel gear assembly includes first and second bevel gear wheels. The first bevel gear wheel is situated at the end of the worm screw of the emergency actuator. The second bevel gear wheel has an axle which projects from the housing orthogonally with respect to the center axis of the worm screw of the emergency actuator. This axle may have an outer or inner contour of multiple teeth. These multiple teeth are used as an adapter for accommodating a tool such as a hexagonal socket or head wrench. Actuation causes the second bevel gear wheel to act on the first bevel gear wheel thus allowing the ring gear of the planetary gear drive to be set in rotation. During normal operation, the opening in the emergency actuator receptacle is closed by a suitable cover.

In accordance with an embodiment of the present invention, an adjustment drive for adjusting a movable component of a vehicle includes a worm gear drive, a planetary gear drive, and an emergency actuator which are accommodated in a housing. The worm gear drive drives the planetary gear drive upon being driven by a drive motor. The emergency actuator acts on the planetary gear drive. The ring gear of the planetary gear drive has external teeth which are accommodated and guided by a cylindrical receptacle in the housing. The external teeth of the ring gear engage with a worm screw of the emergency actuator. The adjusting drive, despite its flat design, contains the emergency actuator integrated therein.

The above features, and other features and advantages of the present invention are readily apparent from the following detailed description thereof when taken in connection with the accompanying drawings. It is understood that the features stated above and to be explained below may be used not only in the particular stated combination, but also in other combinations or alone without departing from the scope of the present invention.

Exemplary embodiments of the present invention are illustrated in the drawings and explained in greater detail in the following description. Identical, similar, or functionally equivalent components are denoted by the same reference numerals.

### BRIEF DESCRIPTION OF THE DRAWINGS

FIG. 1 illustrates an opened top view of an adjustment drive in accordance with an embodiment of the present invention;

FIG. 2 illustrates an opened perspective view of the adjustment drive; and

FIG. 3 illustrates a cross-sectional view of the adjustment drive.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

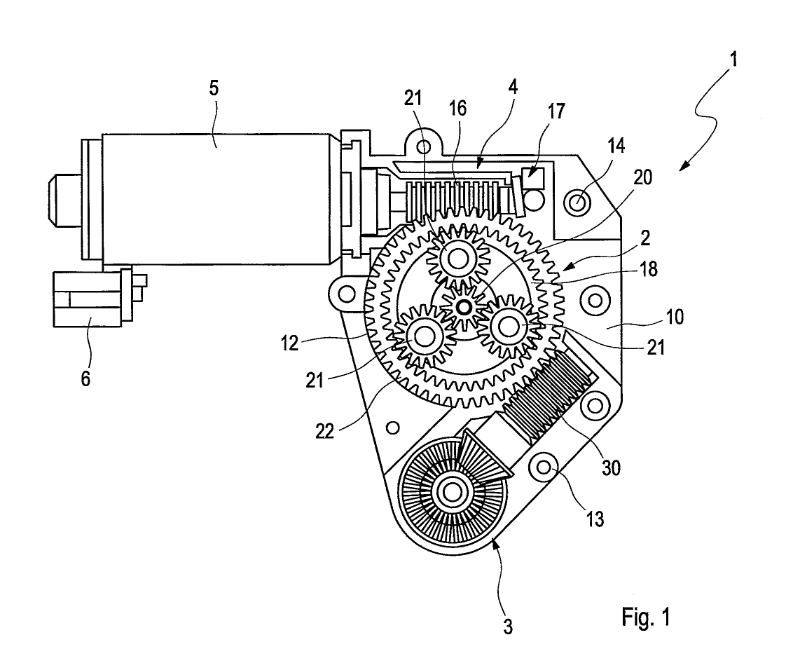

Referring now to FIGS. 1, 2, and 3, an adjustment/closure drive 1 in accordance with an embodiment of the present invention will be described. Adjustment drive 1 generally includes a planetary gear drive 2, an emergency actuator 3, and a worm gear drive 4. Adjustment drive 1 further includes a housing 7. Housing 7 has a bottom part 10 and a top part 11. Planetary gear drive 2, emergency actuator 3, and worm gear drive 4 are housed within housing 7 between bottom and top housing parts 10, 11.

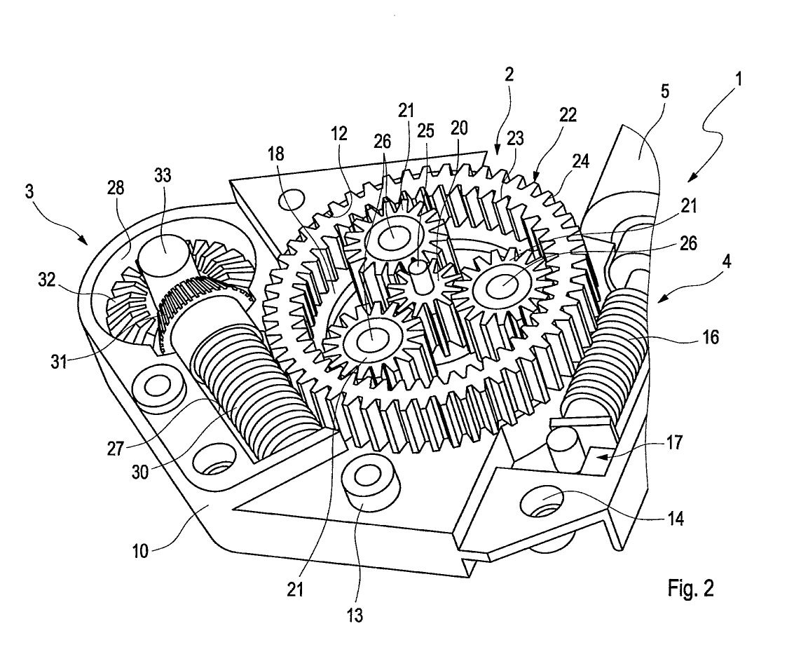

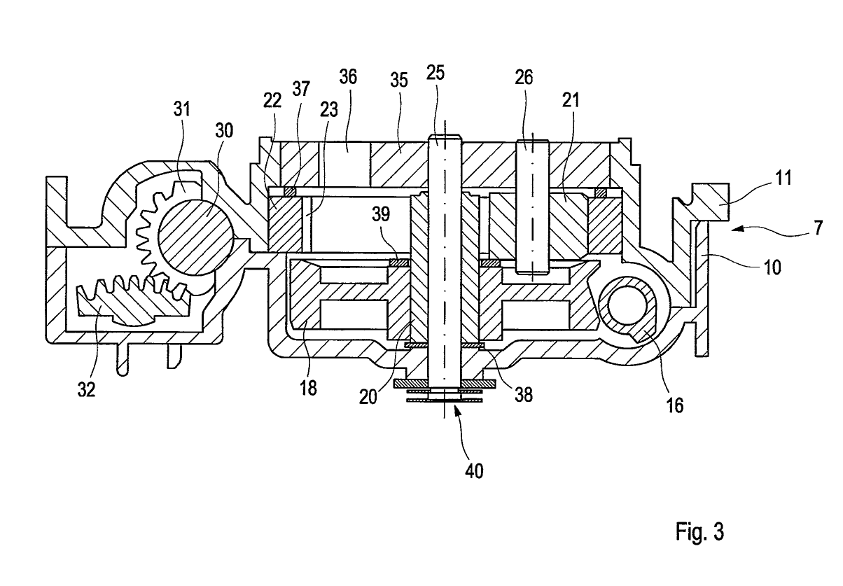

FIGS. 1 and 2 illustrate top and perspective views, respectively, of adjustment drive 1 with housing 7 open on one side (i.e., with top housing part 11 removed). FIG. 3 illustrates a cross-sectional view of adjustment drive 1.

As described below, planetary gear drive 2 includes a ring gear 22, first, second and third planet wheels 21, a planet carrier 35, and a sun wheel 20. Emergency actuator 3 includes a worm wheel 30. Worm gear drive 4 includes a worm wheel 18.

Adjustment drive 1 further includes an electric drive motor 5. Drive motor 5 is supplied with electric power via an electrical connector 6. Drive motor 5 is accommodated in a corner region of housing 7 and is fixed in position within housing 7 by a positive fit. Drive motor 5 includes a drive shaft. The drive shaft extends into housing 7 on the side of drive motor 5 facing housing 7. The portion of the drive shaft within housing 7 is in the form of a drive worm 16. Drive worm 16 projects freely into housing 7 and may experience bending during operation as a result of worm wheel 18 of worm gear drive 4. Thus, the end of drive worm 16 opposite from drive motor 5 is supported on a support 17.

Drive worm 16 includes helical teeth. The teeth of drive worm 16 engage in teeth of worm wheel 18 of worm gear drive 4. Worm wheel 18 acts as a drive gear wheel for the entire gear assembly. The geometry of the teeth of worm wheel 18 correspond to the helical teeth of drive worm 16. Worm wheel 18 is rotatably supported in housing 7 by an axle 25.

Planetary gear drive 2 is situated a small distance from and parallel to worm wheel 18 such that worm wheel 18 is accommodated and guided by cylindrical receptacles in housing 7 (composed of bottom and top housing parts 10, 11). Cylindrical receptacles 12 are present in segmented form on bottom and top housing parts 10, 11, thus ensuring complete guiding of worm wheel 18 and of ring gear 22 of planetary gear drive 2 when housing 7 is closed.

As indicated above, planetary gear drive 2 includes ring gear 22, three planet wheels 21, planet carrier 35, and sun wheel 20. Ring gear 22 has internal teeth 23 and external teeth 24. Internal teeth 23 engage with planet wheels 21. Planet wheels 21, as small gear wheels, are rotatably located on planet carrier 35 by respective axles 26, thus ensuring that their position relative to one another is unchangeable. Planet wheels 21 face the center of ring gear 22 and engage in the external teeth of sun wheel 20. Sun wheel 20 is rigidly connected to worm wheel 18 of worm gear drive 4 by a positive fit. The geometry of external teeth 24 of ring gear 22 is such that the tips of external teeth 24 may be guided in cylindrical receptacle 12 of housing 7.

Emergency actuator 3 is introduced in housing 7 on the side of planetary gear drive 2 opposite from worm gear drive 4. As indicated above, emergency actuator 3 includes a worm screw 30. Worm screw 30 engages in external teeth 24 of ring gear 22. As a result of this engagement, worm screw 30 has a self-locking effect such that ring gear 22 is fixed during normal operation. This self-locking between worm screw 30 and ring gear 22 is achieved by a corresponding small helical pitch of worm screw 30.

Drive worm 16 of drive motor 5 is set in rotation during operation of drive motor 5. This rotation is transferred from drive worm 16 to worm wheel 18 of worm gear drive 4. As a result of the fixed connection between worm wheel 18 and sun wheel 20 of planetary gear drive 2, sun wheel 20 rotates synchronously about its axle 25 with worm wheel 18. As a result of their teeth engagement, planet wheels 21 are set in rotation corresponding to their axles 26. The rotation causes planet carrier 35 to turn as planet carrier 35 is coupled to planet wheels 21 via axles 26.

The configuration of planetary gear drive 2, emergency actuator 3, and worm gear drive 4 allows a flat design of the overall adjustment drive 1. The division of housing 7 into bottom and top housing parts 10, 11 is advantageous for rapid assembly. This is assisted by housing fixing elements 13 present in the contact region of housing parts 10, 11 so that both housing parts may be easily brought together. When suitable fasteners are used, housing parts 10, 11 may be screwed together via drilled holes 14. Additional drilled holes 14 of this type may be used for installation and fixing of the overall adjusting drive/closure drive 1.

In FIG. 2, worm wheel 18 of worm gear drive 4, planetary gear drive 2 positioned parallel to worm wheel 18, and emergency actuator 3 in engagement with ring gear 22 of planetary gear drive 2 are particularly identifiable. Worm screw 30 of emergency actuator 3 is accommodated and guided in two half-portions of a cylindrical receptacle 27 in bottom and top housing parts 10 and 11, respectively. The free end of worm screw 30 is in the form of a first bevel gear wheel 31. A second gear wheel is rigidly connected to an axle 33 which projects at least from one side of housing 7. First bevel gear wheel 31 engages a second bevel gear wheel 32. The outer diameter of second bevel gear wheel 32 has a cylindrical design. As such, second bevel gear wheel 32 is accommodated and guided in a cylindrical receptacle 28 in bottom housing part 10.

Axle 33 projecting from housing 7 can accommodate an emergency actuator tool having a polygon socket or head. As such, engagement of this tool results in transfer of rotational motion to second bevel gear wheel 32 via axle 33. This rotational motion is transferred via the teeth between first and second bevel gear wheels 31 and 32 to worm screw 30. In turn, worm screw 30 transfers this rotational motion to ring gear 22 of planetary gear drive 2 via the teeth engagement between worm screw 30 and ring gear 22.

Ring gear 22, which is accommodated and guided in cylindrical receptacle 12, is thus set in rotation. This rotation of ring gear 22 sets planet wheels 21 in self-rotation via internal teeth 23 of ring gear 22. This self-rotation of planet wheels 21 is transferred to planet carrier 35 via axles 26. Planet carrier 35, illustrated as a locking disk in FIG. 3, is provided for the gear assembly. The rotational motion of planet carrier 35 is thus transferred to a closure element such as a locking hook or other kinematics via a carrier opening 36.

When the rotational motion of planet carrier 35 is generated via emergency actuator 3, sun wheel 20, which is rigidly connected to worm wheel 18, remains fixed in position due to the self-locking between worm wheel 18 and drive worm 16. Thus, the axle of drive motor 5 is not able to rotate.

The cross-sectional view in FIG. 3 of the gear assembly together with emergency actuator 3 shows the interaction between worm gear drive 4, planetary gear drive 2, and planet carrier 35. Again, planet carrier 35 is used to transfer the rotational motion via a carrier opening 36 for the element to be adjusted. Housing 7 is shown in the closed illustration of bottom and top housing parts 10, 11. As previously described for FIG. 2, worm wheel 18 is connected to sun wheel 20 of planetary gear drive 2 by a positive fit. Sun wheel 20 is supported on the inner side of bottom housing part 10 via a slide disk 38. Worm wheel 18 has a setback design between its teeth and the accommodation region of sun wheel 20. This allows axles 26 of planet wheels 21 to engage slightly in this setback. The projections of axles 26 are necessary as planet wheels 21, at least in places, rest on an inner diameter of worm wheel 18 by a slide ring 39 and are thus guided axially.

Ring gear 22 is guided axially via a stepped shoulder of bottom housing part 10 in the axial direction. The stepped shoulder is designed as a slide ring 37. Slide ring 37 may also be designed in one piece so as to project from ring gear 22. Slide ring 37 is used to specify the axle position of ring gear 22. The narrow design of slide ring 37 reduces the axial friction of ring gear 22 against top housing part 11 and planet carrier 35.

Planning carrier 35 is used to accommodate axles 26 of plant wheels 21. The outer diameter of planet carrier 35 has a cylindrical design and is guided in top housing part 11. Planet carrier 35 has opening 36 for a carrier. The carrier may be designed in the form of a pin or screw which engages in planning carrier 35. Of course, other embodiments of the carrier are conceivable such that a projecting coupling element could be used instead of opening 36.

Planet carrier 35 and sun wheel 20 of planetary gear drive 2 and worm wheel 18 of worm gear drive 4 are essentially supported by one axle 25. Axle 25 may be pressure-molded with planet carrier 35 in the passage region of planet carrier 35. Axle 25 can project from planet carrier 35 in one piece with same. Axle 25 projects through bottom housing part 10 on the side of the axle opposite from planet carrier 35. Axle 25 is axially secured and fixed to the exterior of bottom housing part 10 by a pin or a boat securement.

### LIST OF REFERENCE NUMERALS

1 Adjustment unit, closure drive, adjusting drive
2 Planetary gear drive
3 Emergency actuator
4 Worm gear drive
5 Drive motor
6 Electrical connector
7 Housing
10 Bottom housing part
11 Top housing part
12 First cylindrical receptacle
13 Housing fixing element
14 Drilled hole
16 Drive worm
17 Drive worm support
18 Worm wheel, drive gear wheel
20 Sun wheel
21 Planet wheel
22 Ring gear
23 Internal teeth
24 External teeth
25 Axle, sun wheel axle
26 Axle, planet wheel axle
27 Second cylindrical receptacle
28 Third cylindrical receptacle
30 Worm screw
31 Bevel gear wheel I
32 Bevel gear wheel II
35 Planet carrier, locking disk
36 Opening for carrier
37 Slide ring, clamping ring
38 Slide disk
39 Slide disk
40 Pin securing, bolt securing

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An adjustment assembly comprising:
a worm gear drive configured to be driven by a drive motor;
a planetary gear drive having a ring gear with external teeth, wherein the planetary gear drive is configured to be driven by the worm gear drive;
an emergency actuator having a worm screw; and
a housing which houses the worm gear drive, the planetary gear drive, and the emergency actuator, the housing having a first cylindrical receptacle;
wherein the ring gear by the external teeth of the ring gear is accommodated and guided by the first cylindrical receptacle in the housing;
wherein the external teeth of the ring gear are engaged with the worm screw of the emergency actuator whereby the emergency actuator is configured to act on the planetary gear drive.

2. The assembly of claim 1 wherein:
the housing is formable by a bottom housing part and a top housing part, wherein the first cylindrical receptacle in the housing is formed from the bottom and top housing parts.

3. The assembly of claim 2 wherein:
the housing further includes a second cylindrical receptacle, wherein the second cylindrical receptacle is formed from the bottom and top housing cards;
wherein the worm screw of the emergency actuator is accommodated in the second cylindrical receptacle in the housing.

4. The assembly of claim 1 further comprising:
a bevel gear assembly having a first bevel gear and a second bevel gear in engagement with one another;
wherein the first bevel gear is on an end of the worm screw of the emergency actuator facing away from the engagement with the ring gear;
wherein the second bevel gear is situated orthogonally with respect to the worm screw.

5. The assembly of claim 4 wherein:
the second bevel gear is rotatable about an axle, wherein the axle of the second bevel gear projects at least from one side of the housing.

6. The assembly of claim 5 wherein:
the axle of the second bevel gear wheel has on an end a socket.

7. The assembly of claim 6 wherein:
the housing further includes a second cylindrical receptacle;
wherein the second bevel gear at its outer diameter is accommodated and guided in the second cylindrical receptacle in the housing.

8. The assembly of claim 3 wherein:
the worm screw is guided within the second cylindrical receptacle at the outer diameter of the worm gear drive.

9. The assembly of claim 1 wherein:
the outer face of the external teeth of the ring gear corresponds to an outer face of a cylinder which is interrupted by the external teeth.

10. The assembly of claim 4 wherein:
the worm screw is in the plane of the planetary gear drive and the second bevel gear is in the plane of the worm gear drive.
